(19) United States
(12) Patent Application Publication
(10) Pub. No.: US 2006/0234676 A1
(43) Pub. Date: Oct. 19, 2006

(54) Method and apparatus for authenticating a mobile station in a wireless communication network

(75) Inventors: John M. Harris, Chicago, IL (US); Ronald T. Crocker, St. Charles, IL (US); Sean S. Kelley, Barrington, IL (US); Krsman Kris Martinovich, Streamwood, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/399,772

(22) Filed: Apr. 7, 2006

Related U.S. Application Data
(60) Provisional application No. 60/671,721, filed on Apr. 15, 2005.

(51) Int. Cl. H04M 3/16; H04M 1/66; H04M 1/68

(52) U.S. Cl. 455/410; 455/411

(57) ABSTRACT

A communication system controls access of a mobile station (MS) to a wireless communication network by generating a RAND Token and conveying the RAND Token and associated constraints to the MS prior to a determination by the MS of a need to access the communication network, wherein the RAND Token is used to authenticate the MS and need not be confirmed prior to the access attempt. By providing the MS with a RAND Token that need not be confirmed, as opposed to the prior art where an MS cannot know whether a global random challenge value provided to the MS prior to a determination by the MS of a need to access the communication network is stale and therefore must confirm the global random challenge value before using it, a call may be set up in an expedited fashion.

### CROSS-REFERENCE TO RELATED APPLICATION

This application claims priority from provisional application Ser. No. 60/671,721, entitled “METHOD AND APPARATUS FOR AUTHENTICATING A MOBILE STATION IN A WIRELESS COMMUNICATION NETWORK,” filed Apr. 15, 2005, which is commonly owned and incorporated herein by reference in its entirety.

### FIELD OF THE INVENTION

The present invention relates generally to wireless communication systems, and, in particular, to controlling access of a mobile station to a wireless communication network.

### BACKGROUND OF THE INVENTION

In a typical Code Division Multiple Access (CDMA) cellular network employing IS-2000 authentication procedures, a first mobile station (MS) that desires to originate a message or respond to a page must be authenticated by a network serving the MS based on a response output of an authentication algorithm. A global random challenge value is a random number that is generated by the network and globally broadcast as an input to the authentication algorithm. Based on the global random challenge value and other parameters, the MS computes an authentication response, typically an AUTHR, that is conveyed back to the network by MSs serviced by the network in order to validate an access attempt by the MS. In order to avoid replay attacks on the network, that is, a retransmission of an intercepted authentication response by a second MS different from the first MS, the global random challenge values are frequently changed by the network.

In other words, an MS that determines to originate a message or to respond to a page may be required to be authenticated before being permitted access to the network. When authentication is required, before conveying an origination message or a page response to the network, the MS must first confirm that it has a current global random challenge value. In order to determine that the MS has the current global random challenge value, the MS tunes to a paging channel or common control channel and listens for a message comprising the current global random challenge value (hereinafter referred to as a ‘global random challenge value message’), such as an Access Parameters Message (APM) or an ANSI-41 RAND Message (A41RANDM), or a message comprising an access sequence number corresponding to a current version of global random challenge value and other configuration and access parameter information. The messages comprising a global random challenge value and/or an access sequence number are broadcast to all mobile stations (MSs) listening to the paging or common control channel.

Based on the received global random challenge value or access sequence number, the MS determines if the global random challenge value maintained by the MS has become stale, that is, is no longer valid and up-to-date. If the maintained global random challenge value has become stale, the MS replaces the value maintained by the MS with an updated global random challenge value. For example, if the message received by the MS includes the global random challenge value, then the MS replaces the value maintained by the MS with the value included in the message. However, if the message received by the MS merely includes the access sequence number, then the MS tunes to a paging channel or common control channel and listens for another message comprising the current global random challenge value. Upon determining that the maintained global random challenge value is up-to-date or updating the maintained value, the MS generates an 18-bit authentication response (AUTHR) based on the up-to-date global random challenge value as well as other data unique to the mobile such as an SSD (Shared Secret Data), a MIN (Mobile Identification Number), and an ESN (Electronic Serial Number), and includes this parameter upon system access. Upon receipt of the authentication response (AUTHR), the network independently calculates the AUTHR and compares it to the value received from the MS. If the results match, the MS is considered authentic and may then proceed to access the network.

Waiting for a confirmation that a global random challenge value is up-to-date may introduce significant call set up delay as access sequence numbers and global random challenge values may be transmitted by a network as infrequently as every 1.28 seconds. For example, in a peak loaded cell, global random challenge value messages comprising global random challenge values may be squeezed out by other radio frequency (RF) traffic in order to free up RF capacity. On the other hand, a more frequent conveyance of global random challenge values detrimentally impacts system and paging channel capacity. In addition, global random challenge value erasures may further increase a wait time of an MS for a global random challenge value.

Therefore, there exists a need for a method and apparatus for reducing call set up delay resulting from the need of an MS to confirm that a globally broadcast global random challenge value is up-to-date prior to accessing a wireless communication system network.

### BRIEF DESCRIPTION OF THE DRAWINGS

FIG. 1 is a block diagram of a wireless communication system in accordance with an embodiment of the present invention.

FIG. 2 is a block diagram of an architecture of the mobile station of FIG. 1 in accordance with an embodiment of the present invention.

FIG. 3 is a block diagram of an architecture of the base stations of FIG. 1 in accordance with an embodiment of the present invention.

FIG. 4 is a logic flow diagram of steps executed by the communication system of FIG. 1 in provisioning a RAND Token to a mobile station in accordance with various embodiments of the present invention.

FIG. 5 is a logic flow diagram of steps executed by the communication system of FIG. 1 in deprovisioning a RAND Token in accordance with various embodiments of the present invention.

FIG. 6 is a logic flow diagram of steps executed by the communication system of FIG. 1 in executing an intra-network transfer of a RAND Token in accordance with various embodiments of the present invention.

### DETAILED DESCRIPTION OF THE INVENTION

To address the need for a method and apparatus for reducing call set up delay resulting from the need of an MS to confirm that a globally broadcast global random challenge value is up-to-date prior to accessing a wireless communication system network, a communication system is provided that controls access of a mobile station (MS) to a wireless communication network by generating a RAND Token and conveying the RAND Token to the MS prior to a determination by the MS of a need to access the communication network, wherein the RAND Token is used to authenticate the MS and need not be confirmed prior to the access attempt. By providing the MS with a RAND Token that need not be confirmed, as opposed to the prior art where an MS cannot know whether a global random challenge value provided to the MS prior to a determination by the MS of a need to access the communication network is stale and therefore must confirm the global random challenge value before using it, a call may be set up in an expedited fashion. In addition, the RAND Token provided by the communication system may be subject to constraints known to the MS, unlike the prior art global random challenge value which can change at any moment, so the MS can self-determine whether the RAND Token maintained by the MS is current without having to capture an overhead message, unlike with the global random challenge value of the prior art.

Generally, an embodiment of the present invention encompasses a method for controlling access of an MS to a wireless communication network. The method includes generating a RAND Token, conveying the RAND Token to an MS, and conveying one or more constraints on a use of the RAND Token to the MS, wherein the RAND Token is used to authenticate the mobile station and a validity of the RAND Token is determined based on the one or more constraints.

Another embodiment of the present invention encompasses a method for accessing a wireless communication network. The method includes receiving a RAND Token, storing the RAND Token, subsequent to receiving the RAND Token, determining to access the wireless communications network, and conveying an authentication response based on the RAND Token and optionally an indicator of the RAND Token value used to the wireless communication network as part of an authentication process without confirming, between the determining to access the wireless communications network and the conveying the authentication response, whether the RAND Token is up-to-date by reference to overhead message.

Yet another embodiment of the present invention encompasses a base station comprising a processor that is configured to generate a RAND Token for an MS and convey the RAND Token and associated constraints on the use of the RAND Token to the MS prior to a next system access by the mobile station, wherein the RAND Token is used to authenticate the MS.

Still another embodiment of the present invention encompasses a mobile station that includes an at least one memory device and a processor configured to receive a RAND Token prior to a determination to perform a next wireless communications network access, store the RAND Token in the at least one memory device, and authenticate the mobile station by conveying an authentication response based on the RAND Token and optionally an indicator of the RAND Token value used to the wireless communications network without confirming, between the determining to perform a next wireless communications network access and the conveying the RAND Token, whether the RAND Token is up-to-date by reference to overhead message.

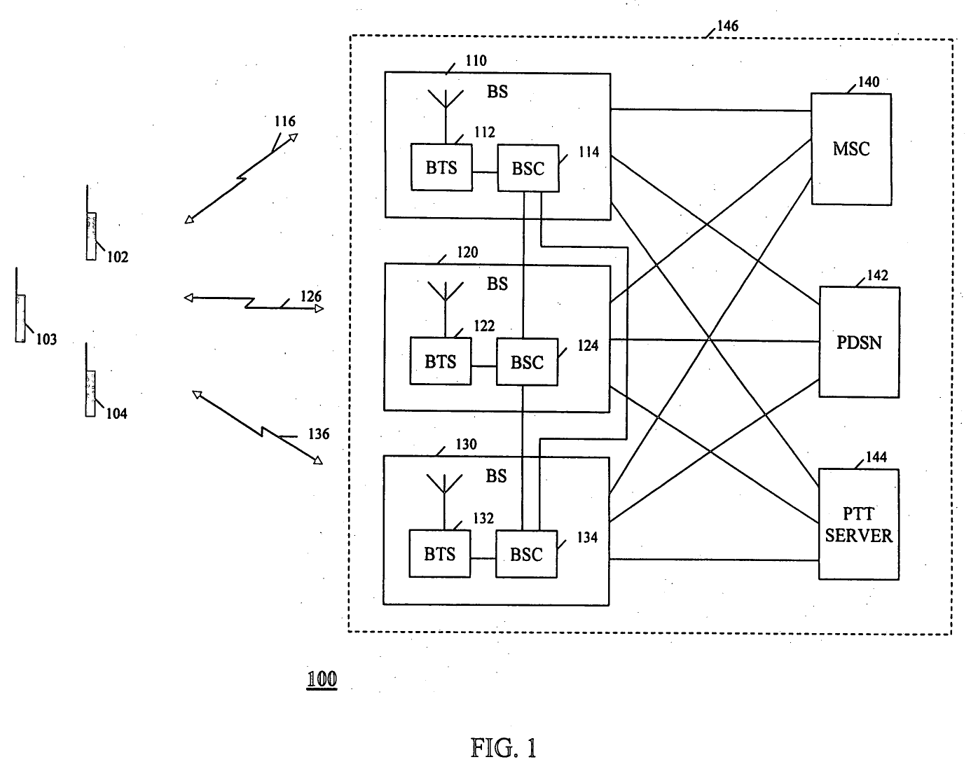

The present invention may be more fully described with reference to FIGS. 1-6. FIG. 1 is a block diagram of a wireless communication system 100 in accordance with an embodiment of the present invention. Communication system 100 includes multiple base stations (BSs) 110, 120, 130 (three shown) that each comprises a respective base transceiver station (BTS) 112, 122, 132 operably coupled to a respective base station controller (BSC) 114, 124, 134. Communication system 100 further includes a Mobile Switching Center (MSC) 140, a Packet Data Support Node (PDSN) 142, and a Push-to-Talk (PTT) Server 144, such as a Dispatch Application Processor available from Motorola, Inc., of Schaumburg, Ill., or a Push-to-Talk over Cellular (PoC) Server as is know in the art, coupled to each of BS 110, 120, and 130, and in particular to each of BSCs 114, 124, and 134. However, in other embodiments of the present invention, one or more of BSs 110, 120, and 130 may be coupled to an MSC or a PDSN that is different from the MSC or PDSN coupled to the other BSs. Each of the multiple BSCs 114, 124, and 134 may further be coupled to each other. BSs 110, 120, and 130, MSC 140, PDSN 142, and PTT Server 144 collectively are referred to herein as a network 146 of the communication system and each of BTSs 112, 122, 132, BSCs 114, 124, 134, MSC 140, PDSN 142, and PTT Server 144 comprises a network element of the communication system.

Communication system 100 further includes multiple mobile stations (MSs) 102-104 (three shown), such as but not limited to cellular telephones, radiotelephones, wireless communication-enabled personal digital assistants, wireless communication-enabled data terminal equipment, such as a wireless communication-enabled laptop computer, or any other type of portable wireless communication device that is capable of operating in a wireless communication system. Each BS 110, 120, 130 provides communication services to MSs, such as MSs 102-104, residing in a coverage area serviced by the BS via a respective air interface 116, 126, 136. Each of air interfaces 116, 126, and 136 comprises a forward link having multiple communication channels, such as one or more forward link control channels, one or more forward link traffic channels, a forward link paging channel, and a forward link pilot channel, and a reverse link having multiple communication channels, such as one or more reverse link control channels, one or more reverse link traffic channels, and one or more reverse link access channels.

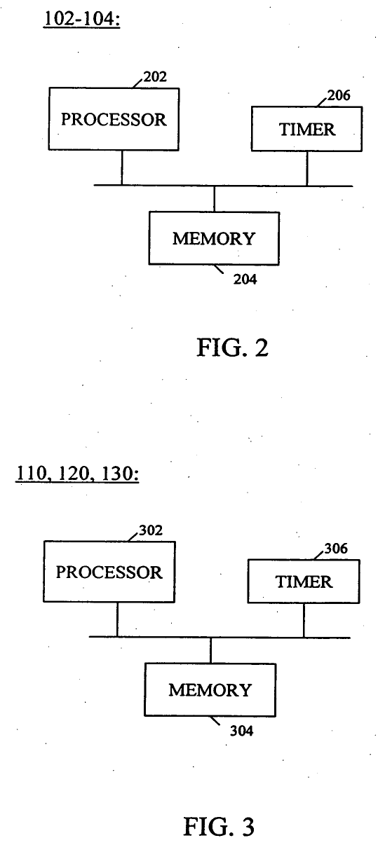

FIGS. 2 and 3 are block diagrams of respective architectures of MSs 102-104 and BSs 110, 120, and 130, in accordance with an embodiment of the present invention. Each of MSs 102-104 and BSs 110, 120, and 130 includes a respective processor 202, 302 such as one or more microprocessors, microcontrollers, digital signal processors (DSPs), combinations thereof or such other devices known to those having ordinary skill in the art. Each of MSs 102-104 and BSs 110, 120, and 130 further includes a respective at least one memory device 204, 304 such as random access memory (RAM), dynamic random access memory (DRAM), and/or read only memory (ROM) or equivalents thereof, that is associated with the respective processor 202, 302 of the MS and BS and that stores data and programs that may be executed by the associated processor and that allows the MS or BS to perform all functions necessary to operate in communication system 100. The at least one memory device 204 of each MS 102-104 further maintains a mobile station identifier (MS ID) that is uniquely assigned to the MS and, when appropriate, an Active Set of pilot channels (hereinafter also referred to as pilots) monitored by the MS. The at least one memory device 304 of each BS 110, 120, 130 further maintains an MS ID and, when appropriate, an Active Set of pilot channels associated with each MS serviced by the BS. Each of MSs 102-104 and BSs 110, 120, and 130 further includes a respective timer 206, 306 coupled to the processor of the MS or BS.

The embodiments of the present invention preferably are implemented within each of MSs 102-104 and BSs 110, 120, and 130, and more particularly with or in software programs and instructions stored in the at least one memory devices 204, 304 and executed by the processors 202, 302 of the MSs and BSs. With respect to BSs 110, 120, and 130, the functionality described herein as being performed by each such BS, and in particular by a processor 302 of the BS, may be performed by a processor of a BTS 112, 122, 132 or a processor of a BSC 114, 124, 134 associated with the BS, or may be distributed among the processors of the BTS and the BSC associated with the BS, based on data and programs correspondingly stored in an at least one memory device of the BTS or BSC. However, one of ordinary skill in the art realizes that the embodiments of the present invention alternatively may be implemented in hardware, for example, integrated circuits (ICs), application specific integrated circuits (ASICs), and the like, such as ASICs implemented in one or more of MSs 102-104, BTSs 112, 122, 132, and BSCs 114, 124, and 134. Based on the present disclosure, one skilled in the art will be readily capable of producing and implementing such software and/or hardware without undo experimentation.

Communication system 100 comprises a wireless packet data communication system. In order for an MS to communicate with the network, each of MSs 102-104, BSs 110, 120, and 130, MSC 140, PDSN 142, and PTT Server 144 operates in accordance with well-known wireless telecommunications protocols. By operating in accordance with well-known protocols, a user of MS 102 can be assured that the MS will be able to communicate with a serving BS and via, the BS, with the other elements of network 146. Preferably, communication system 100 operates in accordance with the 3GPP2 and TIA/EIA (Telecommunications Industry Association/Electronic Industries Association) IS-2000 or IS-2001 standards, which provides compatibility standards for cdma2000 or 1xEV-DO systems. The standard specifies wireless telecommunications system operating protocols, including radio system parameters and call processing procedures. However, those who are of ordinary skill in the art realize that communication system 100 may operate in accordance with any one of a variety of wireless packet-oriented voice communication systems, such as a Global System for Mobile communication (GSM) communication system, a Universal Mobile Telecommunication Service (UMTS) communication system, a Time Division Multiple Access (TDMA) communication system, a Frequency Division Multiple Access (FDMA) communication system, or an Orthogonal Frequency Division Multiple Access (OFDM) communication system.

When an MS 102-104 seeks to access network 146, the MS must first be authenticated by the network. In the prior art authentication process, in response to determining to originate a call or to respond to a page, the MS tunes to a paging channel or common control channel to receive a global random challenge value that is globally broadcast to all MSs serviced by the network or to confirm a global random challenge value maintained by the MS. The MS then computes an authentication response based on the global random challenge value and conveys the authentication response back to the network. The network then authenticates the MS based on the authentication response.

In order to reduce a delay in a call set up time resulting from the need of an MS to obtain a global random challenge value or to confirm a maintained global random challenge value via an overhead message after determining to access a network, communication system 100 provides for a distribution to an MS of a random challenge value or token (hereinafter referred to as a RAND Token or a RANDT) prior to a determination by the MS of a need to access communication network 146, which RAND Token need not be confirmed via an overhead message. By providing a RAND Token that need not be confirmed via an overhead message, the set up of a call is no longer delayed by the need for the MS, subsequent to the determination to originate or to respond to the page, to tune to a paging channel or common control channel to receive or confirm a global random challenge value. Furthermore, use of the RAND Token may be limited by constraints that are also provided to the MS, thereby allowing the MS to determine if the RAND Token is valid independent of network overhead messages, unlike prior art global random challenge values.

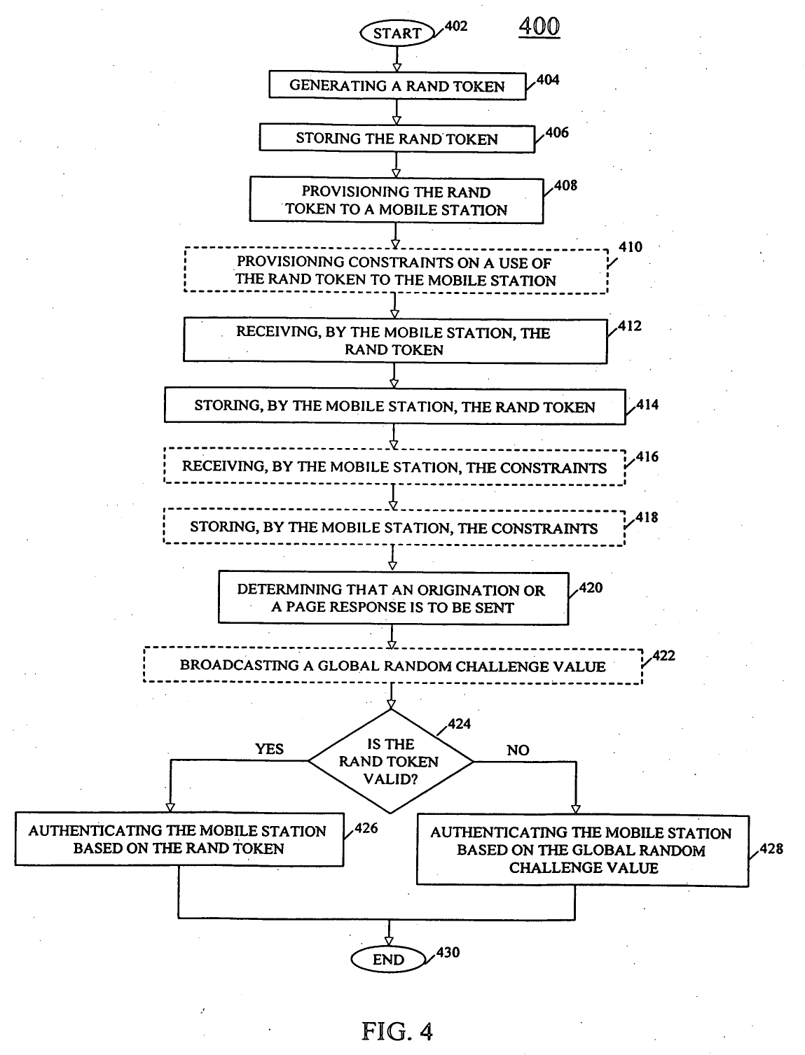

Referring now to FIG. 4, a logic flow diagram 400 is provided that depicts steps executed by communication system 100 in provisioning a RAND Token to an MS in accordance with various embodiments of the present invention. Logic flow diagram 400 begins (402) when a BS, such as BS 110, generates (404), and stores (406) in the at least one memory device 304 of the BS, a RAND Token for use by an MS served by the BS, such as MS 102, to authenticate itself with network 146. The RAND Token may be similar, in construction, to a global random challenge value of the prior art. The RAND token may or may not be personalized for, that is, unique to, the MS and may be usable only a single time or may be usable multiple times by the MS, and may be subject to any constraints upon usage that an operator of communication system 100 may wish to impose, such as a number of times that the RAND Token may be used, a timer value, and so on, depending upon the deployment and how “secure” the network operator wants to make the system against replay attacks.

The serving BS, that is, BS 110, then provisions (408) the RAND Token to the MS, that is, MS 102, by conveying the token to the MS prior to an access attempt, by the MS, of network 146, preferably prior to a determination by the MS of a need to access network 146. BS 110 may convey the RAND Token to MS 102 via a dedicated channel, a common channel, or a paging channel. For example, if the RAND Token is being exchanged as part of a cellular registration, then the token may be exchanged over the paging or common channel. If the token is being exchanged as part of any PTT or presence update/registration, then the token may be exchanged over a dedicated channel. In addition, BS 110 may provision (410) to MS 102, along with the RAND Token, any constraints on usage of the RAND Token imposed by an operator of communication system 100.

In order to facilitate a faster call set up, BS 10 conveys the RAND Token prior to the MS determining to originate a call that will utilize the token and/or prior to the MS determining to respond to a page indicating that a call has been received for the MS, which response will utilize the token. The provisioning of the RAND Token may be initiated by either network 146, and in particular BS 110, or MS 102. For example, BS 110 may convey the RAND Token to the MS when the MS completes an earlier call. That is, upon a completion of the earlier call, BS 110 may convey the RAND Token to the MS in an Extended Release Message via the traffic channel dedicated to the MS for that call. By way of another example, BS 110 may convey the RAND Token to MS 102 via a common signaling channel, such as a paging channel, in response to the MS registering with the BS when the MS activates in, or roams into, the coverage area of the BS.

By way of yet another example, BS 110 may convey the RAND Token in response to speculatively determining that the MS may be about to originate a call or that the MS may be a target of a call. For example, when MS 102 receives an indication from a user of the MS of the user's desire to initiate a call, the MS may convey a request to serving BS 110 via a reverse link common or dedicated channel for a RAND token. For example, an indication of the user's desired to initiate a call may comprise a power up instruction from the user of the MS, such as when a user of the MS opens a clamshell-design MS or depresses a power up key in a user interface of the originating MS, or may comprise an opening of a phone book maintained in the at least one memory device 204 the originating MS by the user of the MS. In response to receiving the request, BS 110 may generate a RAND Token for MS 102 and convey the RAND Token to the MS.

By way of still another example, when MS 102 receives an indication from a user of the MS of the user's desire to initiate a call, the MS may convey a request to network 146 that the network signal potential target MSs included in a buddy list or a talkgroup associated with MS 102 or to signal target MSs selected thus far for a selective dynamic group call. That is, in a selective dynamic group call, a user of an originating MS, such as MS 102, slowly selects and builds a list of target MSs. The ‘buddy list’ comprises a list of MSs, that is, MS IDs, maintained by network 146, and in particular by any of MSC 140, PDSN 142, or PTT Server 144, in association with MS 102, or maintained in the at least one memory device 204 of MS 102, which MSs may signaled by communication system 100 in response to receipt, by network 146, of a signal from MS 102 indicating that the MS is likely to initiate a call. In another embodiment of the present invention, the buddy list may comprise a list of talkgroup IDs associated with talkgroups whose members may be signaled by communication system 100 in response to receipt, by network 146, of a signal from MS 102 indicating that the MS is likely to initiate a call. In yet another embodiment of the present invention, each buddy list may comprise a list of a combination of mobile IDs and talkgroup IDs.

In response to receiving the request to signal potential target MSs, BS 110 may generate a RAND Token for MS 102 and convey the RAND Token to the MS. In addition or in the alternative, in response to receiving the indication of the user's desired to initiate a call and/or while the originator is building the list of targets, network 146 may further generate a RAND Token for each target MS and convey a signal the target MS indicating that the MS is likely to receive a call soon. The signaling of each target MS may include a RAND token for the MS or, in response to receiving the signaling, each target MS may request a token in anticipation of being called.

By way of yet another example, BS 110 may convey the RAND Token in response to a receiving an indication of a presence of a user of an MS, such as MS 102. For example, the user of the MS may set his or her presence, via his or her MS, to “available,” which setting is conveyed to network 146, and in particular to a Presence Server included in network 146 (not shown) via a serving BS, that is, BS 110, as is known in the art. The serving BS may then detect the presence of the use based on the received message, or the Presence Server may, in response to receiving the message, notify the serving BS of the presence of the user. Upon receiving the indication of the presence of the user of the MS, the BS serving the MS, such as BS 110, generates a RAND Token for the MS. The serving BS then conveys the RAND Token to the MS.

In another embodiment of the present invention, the step of conveying the RAND Token to the MS 102 may comprise a step of determining that the MS has a low mobility and/or determining whether there is acceptable capacity available in air interface 116 for a conveyance of the RAND Token. For example, a low mobility MS may comprise an MS that has a low handoff rate, such as an MS that has engaged in a number of idle handoffs that is below a threshold value over a predetermined time period, or may comprise a slow moving MS, that is, an MS that is moving at less than a threshold rate of speed. When network 146, and preferably serving BS 110, determines that MS 102 is a low mobility MS, then network 146, and more particularly BS 110, may generate a RAND Token for the MS, or retrieve a RAND Token maintained in the at least one memory device 304 of the BS, and convey the token to the MS. By determining that the MS has a low mobility prior to conveying the token to the MS, or by determining an RF load level associated with air interface 116 prior to conveying the token to the MS, BS 110 may minimize the likelihood of providing RAND Token to an MS that is likely to soon leave the coverage area of the BS and invalidate the provided token without ever using the token. BS 110 is also aware of the capacity available in air interface 116, that is, the radio frequency (RF) load of the interface. Based in the load determination, for example, by comparing the load determination to a load threshold, BS 110 may determine that there is adequate RF capacity available to convey a RAND Token to MS 102 via a common or dedicated channel of air interface 116, or that the air interface is too heavily loaded to convey the RAND Token. By determining an RF load level associated with air interface 116 prior to conveying the token to the MS, BS 110 may minimize the likelihood of creating congestion in air interface 116 by conveying RAND Tokens.

In yet another embodiment of the present invention, the step of conveying the RAND Token to MS 102 may comprise a step of determining that the MS is participating in, or is invited to participate in, a service requiring a fast response from the MS. For example, Push-to-Talk (PTT) services allow for nearly instantaneous access by an MS originating a call to target MSs, typically by a user of the MS depressing a PTT key. When network 146 receives a request to invite a target MS, such as MS 102, to a PTT communication session from an originating MS, the network, and in particular a BS serving target MS 102, is able to determine, based on the invite, that MS 102 is being request to participate in a service, that is, a PTT service, requiring a fast set up time and, therefore, a quick response. BS 110 may then generate a RAND Token for MS 102, or retrieve a RAND Token maintained in the at least one memory device 304 of the BS, and convey the RAND Token to the MS along with an invitation to join the session.

In response to receiving (412) the RAND Token, MS 102 stores (414) the RAND Token in the at least one memory device 204 of the MS. In various embodiments of the present invention, use of the RAND Token may permissible only in limited circumstances, such as in a limited time period or in a limited geographic area. When constraints imposed on use of the RAND Token are also provided to MS 102 by BS 110, the MS further stores (418) constraints in response to their receipt (416), thereby permitting the MS to determine a validity of the RAND Token without the need to check an overhead message broadcast by network 146. When RAND Token constraints are provided to MS 102 and the MS subsequently determines (420) to attempt to access network 146, such as determining to convey an origination message or a page response to the network, MS 102 may check (424) whether the RAND Token is still valid by referenced to the stored constraints and prior to authenticating itself by use of the RAND Token. By contrast, in the prior art a global random challenge value may be changed at any time by a network and accordingly an MS must always check an overhead message to confirm a validity of a global random challenge value maintained by the MS.

In one embodiment of the present invention, use of the RAND Token may be limited to a coverage area associated with the serving BS 110, such as any one or more of an SID/NID (System Identification number/Network Identification number) zone (that is, a zone associated with a subset of all BSs in communication system 100), a registration zone (that is, a paging area), a packet zone (that is, a coverage area associated with PDSN 142), or a tracking zone (that is, a subset of the Registration zone) that includes BS 110. These geographic limitations may be conveyed to MS 102 along with the RAND Token and stored by the MS in the MS's at least one memory device 204. In the event that the RAND Token is valid in a zone that includes multiple BSs, such as BSs 120 and 130 in addition to BS 110, BS 110 may convey the RAND Token to each of the other BSs in the zone so that any of the BSs in the zone may authenticate MS 102.

In another embodiment of the present invention, the RAND Token may be valid only for a limited period of time. For example, when BS 110 conveys the RAND Token to MS 102, the BS may further convey a timer value, such as a time-to-live value. The timer value is associated with a period of time that the accompanying RAND Token is valid and may be stored by the MS in the MS's at least one memory device 204. In response to receiving the RAND Token and timer value, MS 102 begins counting, by reference to timer 206, a period of time associated with the timer value. When the timer expires, then the RAND Token is no longer valid and the MS may no longer use the RAND Token for authentication purposes. By way of another example, when BS 110 conveys the RAND Token to MS 102, the BS may further convey a deadline at which time the token expires or a time of creation of the token. In the latter instance, the token may then expire upon expiration of a predetermined time period that starts with the time of creation and which predetermined time period is known to the MS or is also conveyed to the MS.

In yet another embodiment of the present invention, the RAND Token may be valid only so long as an MS, such as MS 102, accesses the network on a sector with a pilot that was part of the Active Set at the time when the RAND Token was provided. For example, if the RAND Token was provided to the MS upon release and the Active Set comprised pilots A, B, and C at the end of the call, the MS would only be allowed to use the RAND Token if the next access is in a sector or cell corresponding to pilots A, B, or C. This holds true even if the MS roamed to other pilots while in the idle state such as pilots D, E and F prior to returning to the sector or cell corresponding to pilots A, B, or C for system access.

When MS 102 determines (420) to attempt to access network 146, such as determining to convey an origination message or a page response to the network, the MS may then authenticate (426) itself using the RAND Token without the MS first needing to confirm the validity of the RAND Token based on an overhead message broadcast via a paging channel or a common control channel, such as an Access Parameters Message (APM), an ANSI-41 RAND Message (A41RANDM), or a message comprising an access sequence number corresponding to a current version of a global random challenge value. Logic flow 400 may then end (430). That is, when MS 102 determines to next access network 146, such as to originate a call or to respond to a page, the MS retrieves the RAND Token maintained in the at least one memory device 204 of the MS. When the MS maintains constraints related to a use of the RAND Token, the MS may further determine (424) whether the RAND Token is valid based on the maintained constraints. When no such constraints are maintained by the MS, the MS may assume (424) that the RAND Token is valid so long as the RAND Token is not deprovisoned or cancelled by network 146. When the MS determines that the RAND Token is valid or when no constraints on the use of the token are maintained by the MS, the MS then generates an 18-bit authentication response (AUTHR) based on the maintained RAND Token as well as other data unique to the mobile such as an SSD (Shared Secret Data), a MIN (Mobile Identification Number), and an ESN (Electronic Serial Number), and includes this parameter upon system 100 access.

As a use of the RAND Token may be subject to constraints, which constraints may be provisioned to, and maintained by, the MS, and/or as fewer than all MSs serviced by a BS may be provisioned a RAND Token, a BS, such as BS 110 may further broadcast (422) a global random challenge value via an overhead message to MSs residing in a coverage area of the BS, such as MSs 102-104. When an MS, such as MSs 103 and 104, does not have a RAND Token, or the RAND Token maintained by an MS, such as MS 102, is not valid (424), for example, has expired or is not valid at a current serving BS, then the MS may receive the global random challenge value via the broadcast and use the global random challenge value for authentication (428) in accordance with the prior art. In another embodiment of the present invention, wherein BS 110 determines that there has been a change in configuration information or in access parameter information since the RAND Token was provisioned to MS 102 and desires that the MS capture a most recent Access Parameters Message (APM), or the BS is aware, for whatever reason, that the RAND Token provisioned to MS 102 is no longer valid, BS 110 may issue a Retry Order instructing the MS to re-originate using normal procedures. In response, MS 102 may tune to a paging channel or common control channel associated with serving BS 110 and listen for an APM or an ANSI-41 RAND Message, whichever is appropriate, comprising the current global random challenge value (and, in the case of the APM, current configuration and access parameters information) associated with the broadcasting BS. Upon receiving the global random challenge value, the MS generates an 18-bit authentication response (AUTHR) based on the received global random challenge value as well as other data unique to the mobile such as an SSD (Shared Secret Data), a MIN (Mobile Identification Number), and an ESN (Electronic Serial Number), and includes this parameter upon system 100 access. Logic flow 400 then ends (430).

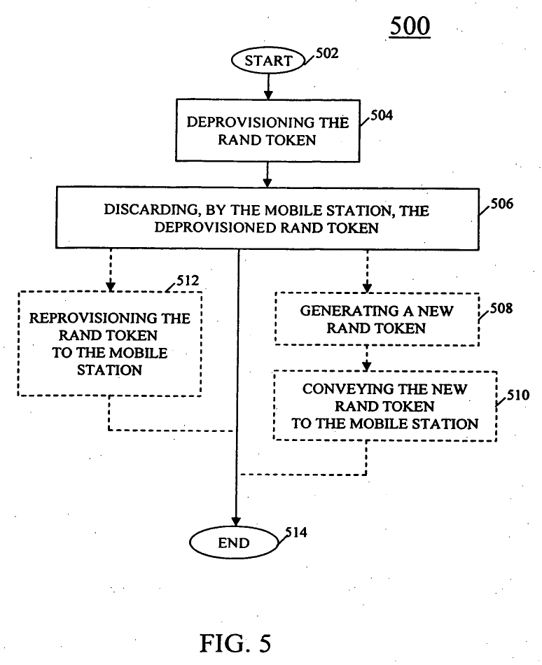

As noted, since a RAND token may be valid only in limited circumstances and an MS, such as MS 102, may assume the RAND Token is valid when it is not, communication system 100, and more particularly BS 110, may further deprovision, or cancel, the RAND Token provided to MS 102. Referring now to FIG. 5, a logic flow diagram 500 is provided illustrating a method by which communication system 500 may deprovison, or cancel, a RAND Token in accordance with various embodiments of the present invention. Logic flow diagram begins (502) when a determination is made (504) to deprovision, or cancel, the RAND Token provided to MS 102. For example, BS 110, rather than MS 102, may determine to cancel or deprovision the RAND Token upon expiration of a predetermined period of time. In various such embodiments of the present invention, the predetermined period of time may comprise a time-to-live, or a time-since-creation, that is measured by the BS by reference to timer 306 of the BS rather than by MS 102, or may correspond to a period of time during which MS 102 has been inactive. For example, the BS 110 may determine that the predetermined period of time has elapsed since the BS last received an indication that the MS is still active in the coverage area serviced by BS 110, such as since the BS last received an access message from the MS. Upon determining that the predetermined period of time has elapsed, BS 110 may cancel the RAND Token and so implicitly inform MS 102. Alternatively, BS 110 may cancel the token by conveying a new RAND Token to the MS. By way of yet another example, BS 110 may determine to deprovision a use of the RAND Token due to a movement of the MS. For example, BS 110 may be informed by network 146, such as by another BS 120, 130 or by MSC 140, that MS 102 has roamed to another coverage area and is serviced by another BS. Upon determining that MS 102 has roamed out of a coverage area, or zone, where the token is valid, BS 110 may cancel the RAND Token and so inform MS 102. In response to being informed of the deprovisioning, or canceling, of the RAND Token, or to the receipt of a new RAND Token, MS 102 may discard (506) the RAND Token currently maintained by the MS and logic flow 500 may end (514).

However, in yet another embodiment of the present invention, in response to a cancellation of the RAND Token provisioned to MS 102, BS 110 may generate (508) a new RAND Token and provision (510) the new RAND Token to MS 102 and logic flow 400 may then end (514). For example, when BS 110 determines that the predetermined period of time has expired, the BS may generate and provision a new RAND Token. On the other hand, when BS 110 determines that MS 102 has roamed to a new coverage area, then the BS may not generate and provision a new RAND Token. However, in the latter instance and as described in greater detail below, when MS 102 has roamed to a new coverage area serviced by a different BS, BS 110 may transfer the RAND Token to the different BS instead of canceling the RAND Token or the different BS may generate a new RAND Token and provision the new token to MS 102.

In still another embodiment of the present invention, BS 110 may determine to deprovision, or cancel, the RAND Token provided to MS 102 in order to assure that the MS receives an overhead message that the MS may otherwise ignore. That is, in the prior art, the global random challenge value is broadcast to all mobile stations (MSs), such as MSs 102-104, residing in a coverage area of a BS, such as BS 110, via an overhead message, typically an Access Parameters Message (APM). In addition to the global random challenge value, the APM includes current configuration information and current access parameters information associated with the broadcasting BS. Often the only information that changes from one APM to a next APM is the current global random challenge value. When an MS, such as MS 102, maintains a valid, RAND Token, the MS may have no need to receive and process each APM broadcast by a serving BS, that is, BS 110. Therefore, in another embodiment of the invention, MS 102 may ignore such overhead messages whenever the MS maintains a valid RAND Token.

A problem that may arise in such an embodiment is that the MS may then miss an overhead message that includes a change in current configuration information or current access parameters information. As a result, in such an embodiment, BS 110 may determine whether any RAND Tokens are outstanding prior to broadcasting an overhead message that includes a change in current configuration information or current access parameters information. When no RAND Tokens are outstanding, BS 110 may change a value of the overhead message and broadcast the overhead message with the changed value. When one or more RAND Tokens are outstanding, then BS 110 may first deprovision each such RAND Token, such as the RAND Token maintained by MS 102, prior to broadcasting the overhead message. BS 110 may then change a value of the overhead message and broadcast the overhead message with the changed value, knowing that MSs that were provisioned a RAND Token, such as MS 102, will now receive and demodulate the overhead message. After broadcasting the overhead message with the changed value, BS 110 may reprovision (512) the RAND Token to one or more of the deprovisioned MSs or may generate (508) new RAND Tokens for, and provision (510) the new tokens to, one or more of the deprovisioned MSs. Logic flow 500 may then end (514).

In yet another embodiment of the present invention, the RAND Token maintained by MS 102 may be invalid without MS 102 being aware of the token's invalidity. For example, MS 102 may have roamed from another coverage area or zone to the coverage area or zone served by BS 110 and never receive a message informing of the invalidity of the token maintained by the MS, or a RAND Token maintained by MS 102 may have be deprovisioned by BS 110 but the message deprovisioning the token is erroneously received by the MS, or BS 110 may provision a new RAND Token to the MS but the message provisioning the new token is erroneously received by the MS. As a result, MS 102 may try to authenticate using an invalid token, with the result that BS 110 rejects the token and the authentication attempt. In this case, the BS may request that the MS use a global random challenge value. In order to expedite a setting up of the call, instead of waiting for MS 102 to authenticate using the global random challenge value before granting MS 102 a traffic channel, BS 110 may grant a traffic channel in air interface 116 to MS 102 in response to receiving the invalid token, and then permit the MS to authenticate with a random challenge value that is provided via the traffic channel. Thus the set up of the traffic channel may begin immediately with a subsequent authentication response provided by the MS on the traffic channel based on the random challenge value rather than global random challenge value.

By providing an MS with a RAND Token prior to a determination by the MS of a need to access the communication network, wherein the RAND Token is used to authenticate the MS and need not be confirmed prior to the access attempt, communication system 100 permits a call to be set up in an expedited fashion relative to the prior art, where any global random challenge value provided to the MS prior to a determination to access a communication network must be confirmed prior to accessing the network. In one embodiment of the present invention, in the absence of a deprovisioning or a canceling of the RAND Token and in response to determining to access the communication network, the MS may assume the RAND Token is valid without the need to confirm the token's validity by monitoring an overhead message. In another embodiment of the present invention, wherein constraints on a use of the RAND Token are provided to, and maintained by, the MS, the MS may, in response to determining to access the communication network (and assuming that the RAND Token has not been deprovisioned or canceled by the network), self-determine whether the RAND Token is valid without the need to confirm the token's validity by monitoring an overhead message. In either instance, by not requiring an MS to monitor a paging channel or a common channel for an overhead message to confirm a validity of a RAND Token maintained by the MS, access to the network is no longer delayed by a wait for such an overhead message.

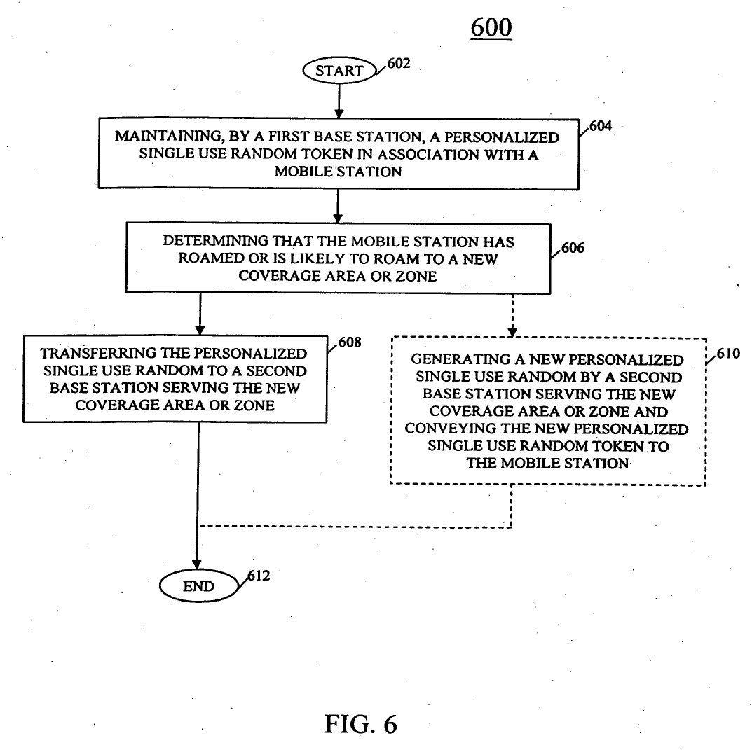

As noted above, when an MS, such as MS 102, that has been provisioned a RAND Token roams to a new coverage area or zone, the RAND Token may be transferred to a BS serving the new coverage area or zone. Referring now to FIG. 6, a logic flow diagram 600 is provided that depicts an intra-network transfer of a RAND Token in accordance with various embodiments of the present invention. The transfer of the token from a first BS, such as serving BS 110, to a second BS, such as BS 120, may be based on a speculation that the MS may access the second BS or may be based on information that the MS has accessed the second BS. Logic flow 600 begins (602) when a first BS, that is, serving BS 110, maintains (604) a RAND Token in association with MS 102. When network 146 determines (606) that MS 102 has roamed or is likely to roam to a new coverage area or zone where the RAND Token is not currently valid, the network transfers (608) the RAND Token to a second BS, such as BS 120, serving the MS in the new coverage area or zone. Logic flow 600 then ends (612).

Network 146 may speculate that that MS 102 is likely to roam to a new coverage area or zone based on any one or more of a mobility of the MS, an air interface quality measurement associated with the air interface of the current serving BS, that is, air interface 116, and/or with an air interface of a potential handoff target, that is, BS 120 and air interface 126, and an anticipated movement of the MS. For example, when the MS has a high mobility, for example, has a high handoff rate, such as an MS that has engaged in a number of idle handoffs that exceeds a threshold value over a predetermined time period, or is determined to be a fast moving MS, that is, an MS that is moving in excess of a threshold rate of speed, then network 146, and more particularly BS 110, may determine to transfer the RAND Token. Network 146 may then determine a direction of movement of MS 102 and transfer the RAND Token to a non-serving BS, such as BS 120, based on the determined direction of movement. There are many well-known techniques for locating an MS and determining a direction of movement and a velocity of the MS, for example, based on changes in a direction of arrival or in times of arrival of signals received by one or more BSs from the MS when the MS is operating in a soft handoff mode, and any such technique may be used herein without departing from the spirit and scope of the present invention.

As noted above, the transfer of the RAND Token to a BS may further, or alternatively, be triggered based on measurements of a quality of the air interface of the current serving BS, that is, air interface 116, and/or a quality of an air interface of a potential handoff target, that is, BS 120 and air interface 126. For example, when MS 102 is operating in an RER mode, the MS periodically measures strengths of Pilot Channels (also referred to as pilots) associated with a Radio Environment Report List, which List includes pilots that are associated with an Active Set or a Neighbor Set of the MS. The RER mode is described in IS-2000-D. In response to changes in measured signal strengths, MS 102 conveys the measured signal strengths to serving BS 110 via a Radio Environment Message (REM). BS 110, and in particular BSC 114, then may use the pilot strength information from the received signal strength measurement reports to determine coverage areas, and associated BTSs, in which to assign dedicated RF resources to the MS and may arrange for a transfer of the RAND Token to the assigned BTS.

By way of another example, MS 102 may determine a quality metric with respect to multiple pilots monitored by the MS, such as a signal strength of each pilot, and convey the quality metric back to serving BS 110. Based on changes in the quality metrics associated with each of the monitored pilots, BS 110 may anticipate a handoff of the MS. For example, MS 102 may measure pilots in an Active Set and/or Neighbor Set of the MS and periodically or intermittently send pilot measurement reports, such as Pilot Strength Measurement Messages (PSMMs), to a serving BS, that is, BS 110. Based on changes in the measure pilot strengths from one pilot measurement report to a next, a movement of the MS to a coverage area associated with a non-serving BS, such as BS 120, may be anticipated and a transfer of the RAND Token to the non-serving BS may be triggered.

In one embodiment of the present invention, the non-serving, or new serving, BS 120 may “pull” the RAND Token from BS 110 in anticipation of, or as a result of, a handoff of MS 102 to BS 120. That is, BS 120 may convey a request to BS 110 for a transfer of the RAND Token. In another such embodiment of the present invention, an intermediate network element, such as MSC 140, may arrange for the transfer of the RAND Token in anticipation of, or as a result of, a handoff of MS 102 from BS 110 to BS 120. In still another embodiment of the present invention, BS 110 may transfer the RAND Token to BS 120 in anticipation of, or as a result of, a handoff of MS 102 to BS 120.

In yet another embodiment of the present invention, instead of transferring the RAND Token to the non-serving, or new serving, BS, that is, BS 120, when network 146 determines (606) that MS 102 has roamed or is likely to roam to a new coverage area where the RAND Token is not currently valid, the BS serving the new coverage area, that is, BS 120, may generate, and convey (610) to MS 102, a new RAND Token. For example, when the measured air interface metric associated with the new coverage area, such as a strength of a pilot associated with the BS serving the new coverage area, exceeds an air interface metric, the BS serving the new coverage area may generate and store a new single use random token that is personalized for MS 102 and convey the new RAND Token to the MS.

Thus communication system 100 provides a RAND Token to an MS, which token's use may be constrained or deprovisioned by the system in any manner that a system operator deems appropriate. The use of the RAND Token may be limited in time and geography, or the system operator may transfer the token through a network in correspondence with the movement of the MS. By providing the RAND Token to the MS prior to a determination by the MS of a need to access the communication network, wherein the RAND Token is used to authenticate the MS and need not be confirmed prior to the access attempt, a call may be set up in an expedited fashion realitve to the prior art. That is, by contrast to the RAND Token provisioned by communication system 100, an MS cannot know whether a global random challenge value of the prior art is stale when the value is provided to the MS prior to a determination by the MS of a need to access the communication network, and therefore the MS must consume time confirming the global random challenge value before using it. In addition, by communication system 100 conditioning a validity of the RAND Token upon constraints known to the MS, the MS may self-determine a validity of the RAND Token without checking an overhead message.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for controlling access of a mobile station to a wireless communication network comprising:
generating a RAND Token;
conveying the RAND Token to a mobile station;
conveying one or more constraints on a use of the RAND Token to the mobile station; and
wherein the RAND Token is used to authenticate the mobile station and a validity of the RAND Token is determined based on the one or more constraints.

2. The method of claim 1, further comprising conveying a global token to a plurality of mobile stations serviced by the wireless communication network.

3. The method of claim 1, wherein conveying the RAND Token comprises:
receiving a request for a RAND Token from a mobile station prior to a next system access by the mobile station; and
in response to receiving the request, conveying the RAND Token to a mobile station.

4. The method of claim 1, wherein conveying the RAND Token comprises:
receiving an indication that a mobile station is likely to be a target of a call;
in response to receiving the indication, conveying the RAND Token to the target mobile station; and
wherein the RAND Token is used to authenticate the target mobile station.

5. The method of claim 1, wherein the constraints on the use of the RAND Token comprise at least one of the mobile station remaining in a given service area, less than a first predetermined quantity of time elapsing since the RAND Token was created, less than a second predetermined quantity of time elapsing since a conveyance by the mobile station of an earlier access message, a failure of the mobile station to correctly receive an instruction to discard the RAND Token, a failure of the mobile station to receive an instruction canceling the RAND Token, and use of the RAND Token only for sectors corresponding to pilots that were part of the Active Set at the time when the RAND Token was received.

6. The method of claim 5, wherein the given service area comprises one or more of an SID/NID zone, a registration zone, a packet zone, and a tracking zone.

7. The method of claim 1, further comprising:
setting, by the mobile station, a flag in an access message to indicate a use of a RAND Token; and
conveying, by the mobile station to the communications network, the authentication response based on the RAND Token and optionally an indicator of the RAND Token value used.

8. The method of claim 1, further comprising:
deprovisioning a use of the RAND Token;
changing a value of an overhead parameters message; and
conveying the overhead parameters message with the changed value.

9. The method of claim 8, further comprising subsequent to conveying the overhead parameters message, re-provisioning a use of the RAND Token.

10. The method of claim 1, further comprising:
determining that no RAND Tokens are outstanding;
in response to the determination, changing a value of an overhead parameters message; and
conveying the overhead parameters message with the changed value.

11. The method of claim 1, further comprising:
determining at least one of a change in configuration information, a change in access parameter information, and that a RAND Token is no longer valid; and
instructing the mobile station to re-originate using a global random challenge value.

12. The method of claim 1, wherein the RAND Token is stored by a first base station and wherein the method further comprises transferring the RAND Token from a first base station to a second base station.

13. The method of claim 12, further comprising triggering the transfer of the RAND Token from the first base station to the second base station based on one or more of a mobility of the mobile station, a Radio Frequency environment report, and an anticipated movement of the mobile station.

14. The method of claim 1, further comprising:
receiving from the mobile station an authentication response based on the RAND Token and optionally an indicator of the RAND Token value used;
rejecting the RAND Token;
granting the mobile station a traffic channel; and
authenticating the mobile station via the traffic channel.

15. The method of claim 1, further comprising:
receiving from the mobile station an authentication response based on the RAND Token;
rejecting the received authentication response;
providing a new random challenge value for re-authentication.

16. The method of claim 1, wherein conveying the RAND Token comprises:
determining a load of an air interface;
comparing the load to a threshold; and
conveying the RAND Token to the mobile station when the load favorably compares to the threshold.

17. The method of claim 1, further comprising:
determining at least one of whether the mobile station is participating in a service requiring a fast response and whether the mobile station is invited to participate in a service requiring a fast response; and
conveying, by the mobile station to the network, the RAND Token in response to the determination that the mobile station is participating in, or is invited to participate in, a service requiring a fast response.

18. The method of claim 1, further comprising:
determining that the mobile station has moved to a new service area; and
in response to the determination, canceling the RAND Token.

19. The method of claim 18, further comprising in response to the determination, conveying a new RAND Token to the mobile station.

20. The method of claim 1, wherein conveying the RAND Token comprises:
determining that the mobile station has a low mobility; and
in response to the determination, conveying the RAND Token to the mobile station.

21. The method of claim 1, wherein conveying the RAND Token comprises:
determining that a user of the mobile station is likely to originate a call; and
in response to the determination, conveying the RAND Token to the mobile station.

22. The method of claim 1, wherein conveying the RAND Token comprises:
determining that a mobile station is likely to be a target of a call; and
in response to the determination, conveying the RAND Token to the mobile station.

23. A method for accessing a wireless communication network comprising:
receiving a RAND Token;
storing the RAND Token;
subsequent to receiving the RAND Token, determining to access the wireless communications network; and
conveying an authentication response based on the RAND Token and optionally an indicator of the RAND Token value used to the wireless communication network as part of an authentication process without confirming, between the determining to access the wireless communications network and the conveying the authentication response, whether the RAND Token is up-to-date by reference to overhead message.

24. The method of claim 23, further comprising:
receiving at least one constraint on a use of the RAND Token; and
storing the at least one constraint.

25. The method of claim 24, wherein conveying comprises:
determining whether the RAND Token is valid based on the at least one constraint; and
wherein conveying comprises, in response to determining that the RAND Token is valid, conveying an authentication response based on the RAND Token and optionally an indicator of the RAND Token value used to the wireless communication network as part of an authentication process.

26. A base station comprising a processor that is configured to generate a RAND Token for a mobile station and convey the RAND Token and associated constraints on the use of the RAND Token to the mobile station prior to a next system access by the mobile station, wherein the RAND Token is used to authenticate the mobile station.

27. The base station of claim 26, wherein the RAND Token is valid only when the mobile station is operating under a circumstance comprising at least one of the mobile station remaining in a given service area, the mobile station accessing on a sector with pilot that was part of the Active Set at the time when the RAND Token was provisioned, less than a first predetermined quantity of time elapsing since the RAND Token was created, less than a second predetermined quantity of time elapsing since a conveyance by the mobile station of an earlier access message, a failure of the mobile station to correctly receive an instruction to discard the RAND Token, a failure of the mobile station to receive an instruction canceling the RAND Token, and use of the RAND Token only for sectors corresponding to pilots that were part of the Active Set at the time when the RAND Token was received.

28. A mobile station comprising:
an at least one memory device; and
a processor configured to receive a RAND Token prior to a determination to perform a next wireless communications network access, store the RAND Token in the at least one memory device, and authenticate the mobile station by conveying an authentication response based on the RAND Token and optionally an indicator of the RAND Token value used to the wireless communications network without confirming, between the determining to perform a next wireless communications network access and the conveying the RAND Token, whether the RAND Token is up-to-date by reference to overhead message.

29. The mobile station of claim 28, wherein the processor is further configured to receive at least one constraint on a use of the RAND Token and wherein the processor stores the at least one constraint in the at least one memory device.

30. The mobile station of claim 29, wherein the processor is further configured to determine whether the RAND Token is valid based on the at least one constraint and wherein the processor conveys an authentication response based on the RAND Token and optionally an indicator of the RAND Token value used to the wireless communication network as part of an authentication process in response to determining that the RAND Token is valid.
